(19) United States
(12) Patent Application Publication
(10) Pub. No.: US 2012/0218480 A1
(43) Pub. Date: Aug. 30, 2012

(54) FLAT TV SOUND ENHANCING FURNITURE

(76) Inventors: JEFFREY EVAN GOLDSTEIN, San Diego, CA (US); Shin Yamaguchi, Tokyo (JP)

(21) Appl. No.: 13/035,330

(22) Filed: Feb. 25, 2011

(51) Int. Cl. H04N 5/64

(52) U.S. Cl. 348/836; 348/E05.128

(57) ABSTRACT

A TV stand supports a TV with a downfiring audio speaker. To reflect the sound from the speaker ninety degrees so the sound propagates away from the plane of the TV toward a viewer, the stand has a top portion with a flat or curved surface which is canted downwardly from rear to front.

### I. FIELD OF THE. INVENTION

The present application relates generally to sound enhancing furniture such as support stands for flat TVs.

### II. BACKGROUND OF THE INVENTION

As TVs become thinner to conserve space and front bezels are reduced or eliminated to present a more appealing appearance, the audio speakers of the TV are typically oriented to project sound downwardly, owing to the lack of clearance in thin TVs to permit orienting speakers to project sound outwardly toward the viewer. As understood herein, this can diminish the listening experience when watching the TV.

### SUMMARY OF THE INVENTION

An assembly includes a base and a TV disposed above the base and supported thereon by a support rod connecting the TV to the base. The TV includes an audio speaker oriented to project sound downwardly toward ground on which the base rests. The base is formed with structure reflecting outwardly relative to the TV sound projected downwardly from the speaker.

In some embodiments the base is formed with a top portion closely juxtaposed with the speaker. The top portion establishes the structure reflecting outwardly relative to the TV sound projected downwardly from the speaker. The top portion may include a continuous solid chamfered surface having a rear portion disposed above a front portion. A reflecting portion of the continuous solid chamfered surface can be flat or in other embodiments can be curved from, e.g., the rear portion to the front portion. The reflecting portion may have end parts and a central part and the end parts can be wider or narrower than the central part. In any case, the reflecting portion of the continuous solid chamfered surface may be continuously curved from the rear portion to the front portion and from the end curved parts to the central curved part such that no slope discontinuities exist on the reflecting portion.

In another example, the top portion includes a top surface defining an opening and below the opening an interior reflecting surface canted downwardly from rear to front relative to the TV.

In another aspect, an assembly includes a TV with a downfiring audio speaker. The TV includes a display defining a plane. A TV stand supports TV. The stand has a top portion with a flat or curved surface which is canted downwardly from rear to front to reflect the sound from the speaker ninety degrees so the sound propagates away from the plane of the TV toward a viewer.

In another aspect, a method includes supporting a TV on a stand and altering a propagation path of audio played by the TV ninety degrees using the stand.

Example implementation details of present principles are set forth in the description below, in which like numerals refer to like parts, and in which:

### BRIEF DESCRIPTION OF THE DRAWINGS

FIGS. 1-3 are perspective views of a first example embodiment of a TV stand assembly, with the speakers shown schematically in FIG. 1 and with portions of the TV display omitted for clarity;

FIGS. 4-6 are perspective views of a second example embodiment of a TV stand assembly, with portions of the TV display omitted for clarity;

FIGS. 7-9 are perspective views of a third example embodiment of a TV stand assembly, with portions of the TV display omitted for clarity;

FIG. 10 is a side schematic view of the embodiment shown in FIGS. 7-9 to illustrate the internal reflecting surface; and

FIGS. 11-13 are perspective views of a fourth example embodiment of a TV stand assembly, with portions of the TV display omitted for clarity.

### DETAILED DESCRIPTION OF THE PREFERRED EMBODIMENT

Terms of direction are relative to the TV display when it is disposed upright in a vertical position.

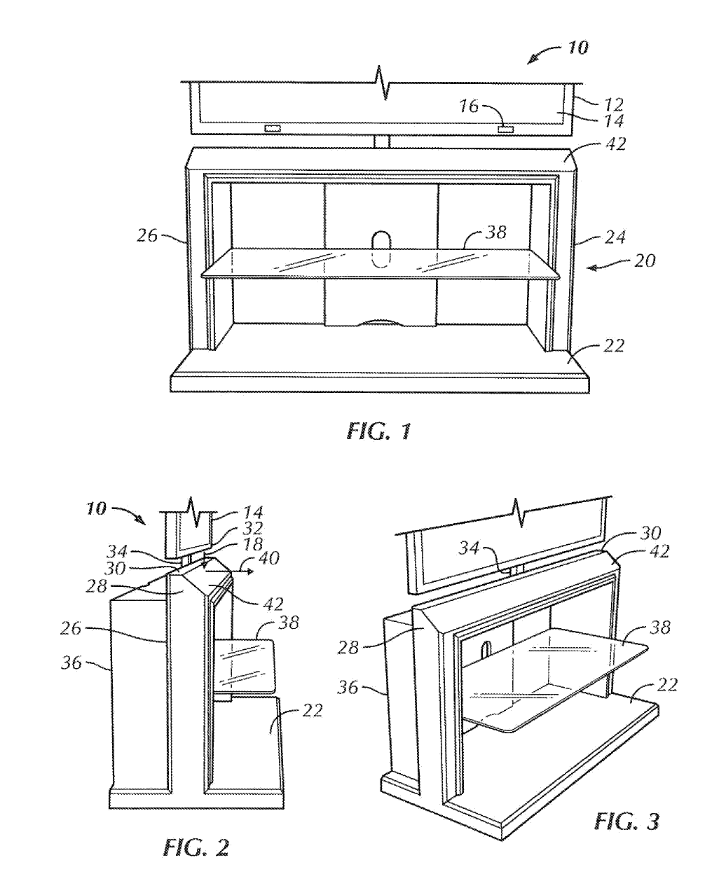

Referring initially to FIGS. 1-3, an assembly 10 includes a TV 12 having a TV display 14 such as a flat panel high definition TV (HDTV) display and one or more audio speakers 16 (shown schematically in FIG. 1). Owing to the relatively thin display 14 and the fact that the speakers 16 are co-housed with the display, the speakers 16 are oriented so that they are “downfiring”, e.g., the speakers emit sound in a direction more or less straight down relative to the display 14 as shown by the arrow 18 in FIG. 2.

The TV 12 of the assembly 10 is supported above a base or stand 20. In the non-limiting example shown, the stand 20 is generally configured as a hollow parallelepiped-shaped structure with a flat horizontal bottom shelf 22, elongated left and right vertical supports 24, 26 extending from the bottom shelf 22 to an elongated horizontal top portion 28 the flat horizontal top surface 30 of which is closely spaced from the bottom edge 32 of the TV 12 (best shown in FIG. 2), and one or more support rods 34 coupling the TV 12 to the stand 20. In the example shown, a rear parallelepiped-shaped support box 36 (FIGS. 2 and 3) is connected to the rod 34 and rests on the bottom shelf 22 behind the vertical supports 24, 26 and top portion 28. The bottom shelf 22, supports 24, 26, and top portion 28 may be made of wood or plastic and the support box 36 may be made of metal. If desired, a horizontal middle shelf 38 that may be made of glass can be supported by the supports 24, 26 between the bottom shelf 22 and top portion 28.

In accordance with present principles, projection of audio from the down firing speakers 16 is enhanced through the use of a uniquely shaped “sounding board” or “sound chamber” installed on the top of the TV stand 20. More specifically, projection is enhanced by diverting (through, e.g., reflection) audio from the speakers 16 propagating down (indicated at 18 in FIG. 2) ninety degrees or so to propagate more or less away from the front of the TV display 14 as indicated by the arrow 40 in FIG. 2 substantially in a normal path to the plane of the display 12, although less acute diversion angles than ninety degrees may be used.

Accordingly, the top portion 28 of the stand 22 is formed with structure reflecting outwardly, relative to the TV, sound projected downwardly from the speakers 16. In the embodiment shown in FIGS. 1-3, the top portion 28 includes a continuous solid flat chamfered surface 42 having a rear portion disposed higher than a front portion as shown. The surface 42 defines a rectangle that extends from edge to edge of the stand 22 and that is angled at approximately forty five degrees with respect to the vertical as shown. With this cooperation of structure, sound travelling in the direction of the arrow 18 is reflected by the surface 42 to propagate generally in the direction shown by the arrow 40.

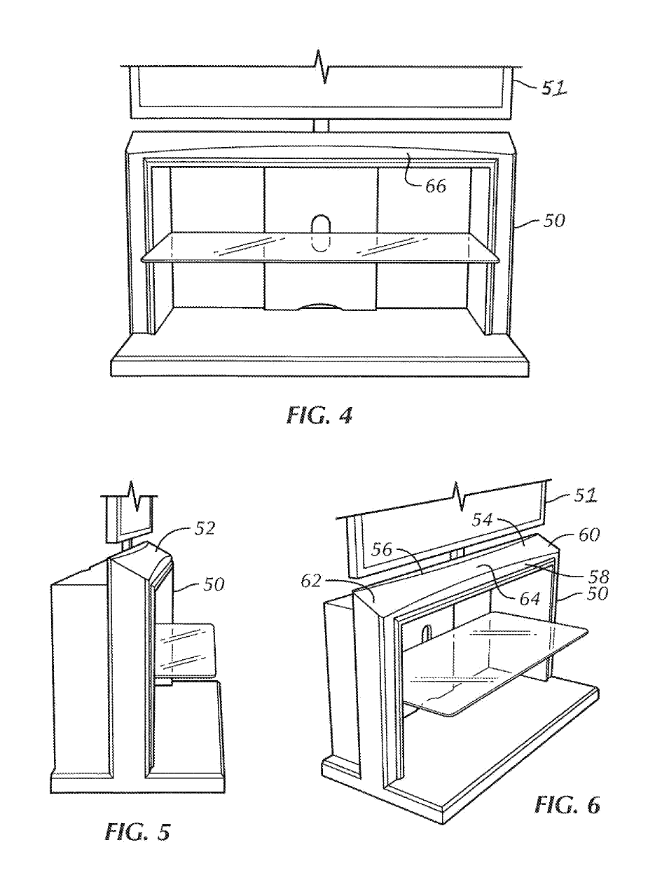

FIGS. 4-6 show an alternate stand 50 for supporting a TV 51 with downfiring speakers that is in all essential respects identical to the stand 22 shown in FIGS. 1-3 with the following exceptions. The top portion 52 of the stand 50 has a reflecting portion 54 that is curved from a rear portion 56 to a front portion 58 of the reflecting portion 54. Also, the reflecting portion 54 has a left end 60 and a right end 62 and may define a slightly convex bowed surface there between as shown. Furthermore, the reflecting portion 54 is wider near the ends 60, 62 than near it center portion 64. With this structure, a front vertical face 66 is formed that extends substantially from end 60 to end 62 in a gentle upside-down “U” shape as best shown in FIG. 4. In any case, the reflecting portion 54 preferably is continuously curved in the dimensions described (i.e., front to back and side to side) so that no slope discontinuities exist on the reflecting portion as shown.

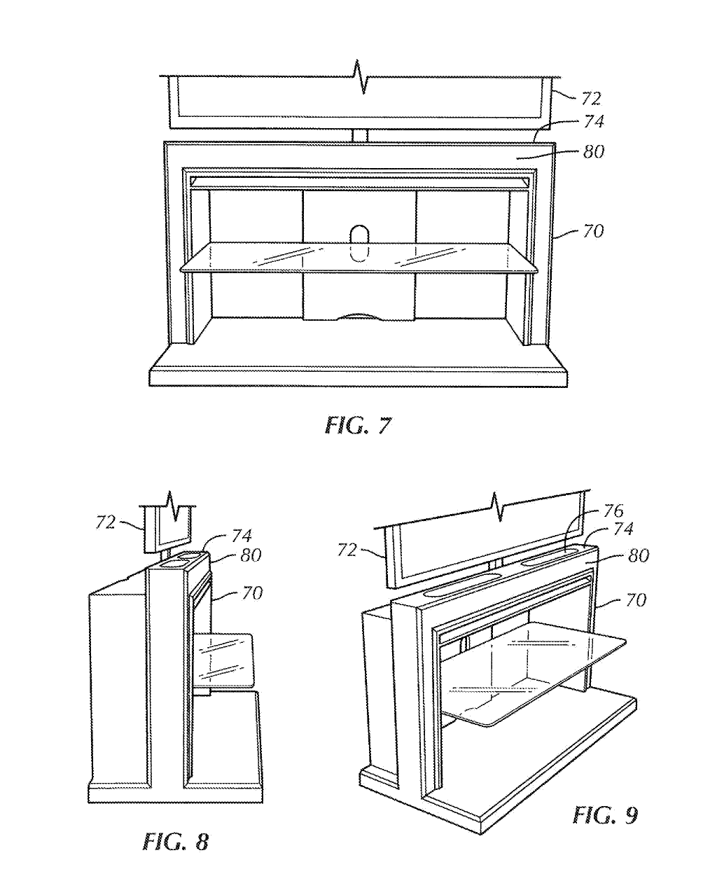

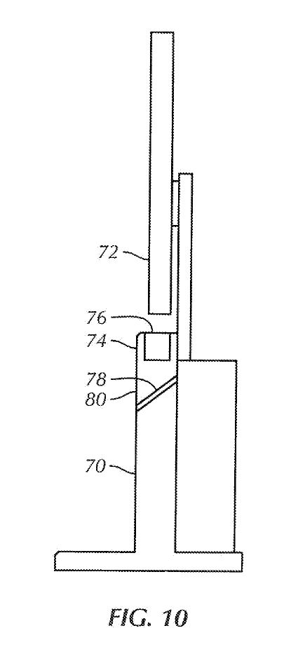

FIGS. 7-10 show an alternate stand 70 for supporting a TV 72 with downfiring speakers that is in all essential respects identical to the stand 22 shown in FIGS. 1-3 with the following exceptions. The top portion 74 of the stand 70 is hollow and is parallelepiped-shaped, and includes at least one and preferably two elongated (from side to side) openings 76, one opening 76 under each downfiring speaker on the TV 72. Sound from the speakers propagates through the openings 76 and into the chamber defined by the hollow top portion 74. A canted reflection flange 78 (FIG. 10) may be disposed within the chamber as shown, oriented at an angle such as a forty five degree angle relative to the vertical. The reflecting flange 78, which may extend completely from one side to the other of the stand 70, is canted downwardly from rear to front relative to the TV. In some embodiments, openings may be provided in the front surface 80 of the top portion 74.

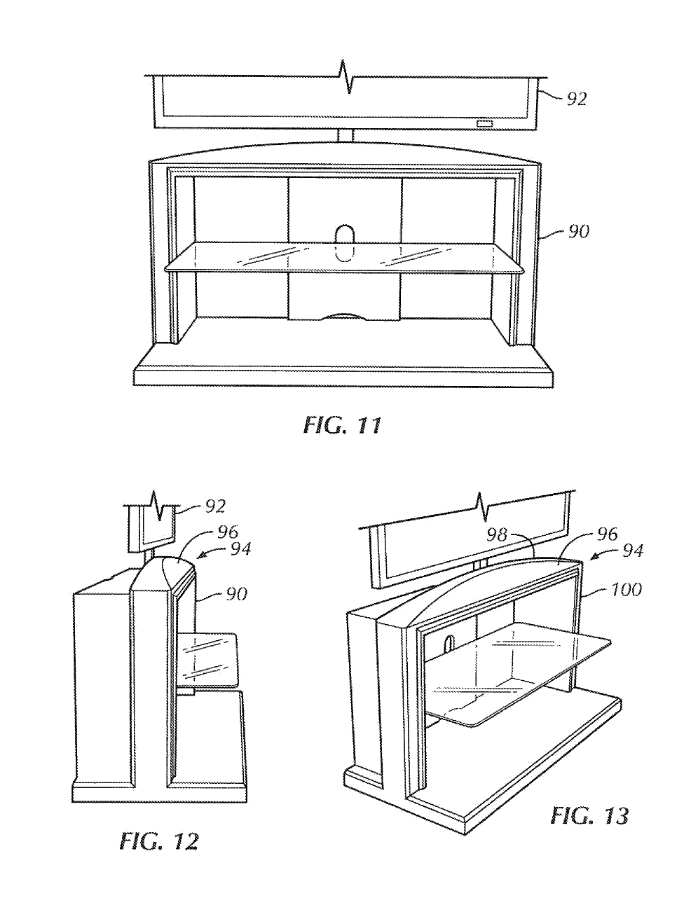

FIGS. 11-13 show an alternate stand 90 for supporting a TV 92 with downfiring speakers that is in all essential respects identical to the stand 22 shown in FIGS. 1-3 with the following exceptions. The top portion 94 of the stand 90 has a reflecting portion 96 with a bow-shaped upper edge 98 and a lower edge 100 that is forward of the upper edge 98. The reflecting portion 96 may be convex from its left end to its right end and may be curved from its rear portion to its front portion, with the center part of the reflecting surface being wider than the end portions.

While the particular FLAT TV SOUND ENHANCING FURNITURE is herein shown and described in detail, it is to be understood that the subject matter which is encompassed by the present invention is limited only by the claims.

What is claimed is:

1. Assembly comprising:
base; and
TV disposed above the base and supported thereon by at least one support rod connecting the TV to the base, the TV including at least one audio speaker oriented to project sound downwardly toward ground on which the base rests, wherein
the base is formed with structure reflecting outwardly relative to the TV sound projected downwardly from the speaker.

2. The assembly of claim 1, wherein the base is formed with a top portion closely juxtaposed with the speaker, the top portion establishing the structure reflecting outwardly relative to the TV sound projected downwardly from the speaker.

3. The assembly of claim 2, wherein the top portion includes a continuous solid chamfered surface having a rear portion disposed above a front portion.

4. The assembly of claim 3, wherein a reflecting portion of the continuous solid chamfered surface is flat.

5. The assembly of claim 3, wherein a reflecting portion of the continuous solid chamfered surface is curved.

6. The assembly of claim 5, wherein the reflecting portion of the continuous solid chamfered surface that is curved defines end curved parts and a central curved part and the end curved parts are wider than the central curved part.

7. The assembly of claim 6, wherein the reflecting portion of the continuous solid chamfered surface is continuously curved such that no slope discontinuities exist on the reflecting portion.

8. The assembly of claim 5, wherein the reflecting portion of the continuous solid chamfered surface defines end parts and a central part and the end parts are narrower than the central part.

9. The assembly of claim 2, wherein the top portion includes a top surface defining an opening and below the opening an interior reflecting surface canted downwardly from rear to front relative to the TV.

10. Assembly, comprising:
a TV with a downfiring audio speaker, the TV including a display defining a plane; and
a TV stand supporting TV, the stand having a top portion with a flat or curved surface which is canted downwardly from rear to front to reflect the sound from the speaker ninety degrees so the sound propagates away from the plane of the TV toward a viewer.

11. The assembly of claim 10, wherein the top portion includes a continuous solid chamfered surface having a rear portion disposed above a front portion.

12. The assembly of claim 11, wherein a reflecting portion of the continuous solid chamfered surface is flat.

13. The assembly of claim 11, wherein a reflecting portion of the continuous solid chamfered surface is curved.

14. The assembly of claim 13, wherein the reflecting portion of the continuous solid chamfered surface defines end parts and a central part and the end parts are wider than the central part.

15. The assembly of claim 14, wherein the reflecting portion of the continuous solid chamfered surface is continuously curved such that no slope discontinuities exist on the reflecting portion.

16. The assembly of claim 10, wherein the top portion includes a top surface defining an opening and below the opening an interior reflecting surface canted downwardly from rear to front relative to the TV.

17. The assembly of claim 13, wherein the reflecting portion of the continuous solid chamfered surface defines end parts and a central part and the end parts are narrower than the central part.

18. Method comprising:
supporting a TV on a stand; and
altering a propagation path of audio played by the TV ninety degrees using the stand.

19. The method of claim 18, wherein the stand includes a reflecting portion that is curved from rear to front relative to the TV.

20. The method of claim 19, wherein the reflecting portion defines end parts and a central part and the end parts have a different width than the central part.
